(19) United States
(12) Patent Application Publication
(10) Pub. No.: US 2024/0246539 A1
(43) Pub. Date: Jul. 25, 2024

(54) METHOD FOR OPERATING AN ACTIVE ROLL SUPPORT SYSTEM OF A MOTOR VEHICLE

(71) Applicant: Dr. Ing. h.c. F. Porsche Aktiengesellschaft, Stuttgart (DE)

(72) Inventors: David Caredda, Ebersbach (DE); Jochen Liebold, Stuttgart (DE); Markus Eisenbarth, Stuttgart (DE)

(73) Assignee: Dr. Ing. h.c. F. Porsche Aktiengesellschaft, Stuttgart (DE)

(21) Appl. No.: 18/390,082

(22) Filed: Dec. 20, 2023

(30) Foreign Application Priority Data
Jan. 25, 2023 (DE) 10 2023 101 753.5

(51) Int. Cl. B60W 30/18; B60W 30/045; B60W 40/06; B60W 40/103; B60W 40/107

(52) U.S. Cl. CPC B60W 30/18145; B60W 30/045; B60W 40/06; B60W 40/103; B60W 40/107; B60W 30/182

(57) ABSTRACT

A method for operating an active roll support system of a motor vehicle, in which a roll moment distribution is regulated below a sideslip angle threshold on the basis of an actual grip reserve of a rear axle relative to a front axle of the motor vehicle. A wheel load is acquired for each of the wheels of the front axle and for each of the wheels of the rear axle and the acquired wheel loads are used as feedback variables in a control loop for regulating the roll moment distribution to calculate the actual grip reserve of the rear axle and compare it with a target grip reserve of the rear axle and from this determine a control deviation for adapting the roll moment distribution.

### CROSS-REFERENCE TO RELATED APPLICATION

This application claims priority to German Patent Application No. 10 2023 101 753.5, filed Jan. 25, 2023, the content of such application being incorporated by reference herein in its entirety.

### FIELD OF THE INVENTION

The present invention relates to a method for operating an active roll support system of a motor vehicle.

### BACKGROUND OF THE INVENTION

Active roll support systems for motor vehicles, which are configured to provide roll support when the vehicle is driving by means of a roll moment distribution in order to minimize rolling movements of the motor vehicle when cornering, are already known from the prior art in a variety of embodiments. Up to now, roll moment distribution in active roll support systems is largely pilot controlled only via the application. The only feedback relating to the current driving state of the motor vehicle are corresponding oversteering or understeering signals, which have often proven to be of little use in practical applications. A major reason for this is that the oversteering or understeering signals are not accurate enough for different road surface friction coefficients, for different tires and for different vehicle configurations. The feedback of the current driving state represented by the oversteering or understeering signals is furthermore delayed.

DE 10 2021 201 831 A1, which is incorporated by reference herein, discloses a method for increasing traction of a motor vehicle with an active roll stabilizer, wherein spinning of a wheel is detected and a wheel contact force of the spinning wheel is reduced by adjusting roll stabilizer settings.

A method for controlling/regulating the driving behavior of a motor vehicle, wherein a roll moment distribution or roll moment support is adapted to a road surface friction coefficient, is known from DE 10 2008 014 104 A1, which is incorporated by reference herein.

### SUMMARY OF THE INVENTION

Described herein is a method for operating an active roll support system of a motor vehicle, in which a roll moment distribution is regulated below a sideslip angle threshold on the basis of an actual grip reserve of a rear axle relative to a front axle of the motor vehicle, wherein a wheel load is acquired for each of the wheels of the front axle and for each of the wheels of the rear axle and the acquired wheel loads are used as feedback variables in a control loop for regulating the roll moment distribution to calculate the actual grip reserve of the rear axle and compare it with a target grip reserve of the rear axle and from this determine a control deviation for adapting the roll moment distribution. The method according to the invention advantageously enables improved operation of an active roll support system of a motor vehicle and improved regulation of the roll moment distribution.

In one embodiment, it is proposed that a grip potential available for longitudinal and lateral forces is calculated for each of the wheels of the front axle and for each of the wheels of the rear axle using at least some of the following variables, preferably using all of the following variables: wheel load, slip angle, slip, tire temperature, wheel camber and coefficient of friction.

In one embodiment, it is provided that a currently available grip potential of the front axle is calculated from the grip potentials of the wheels of the front axle and a currently available grip potential of the rear axle is calculated from the grip potentials of the wheels of the rear axle.

The actual grip reserve of the rear axle can preferably be determined by calculating the difference between the currently available grip potential of the rear axle and the currently available grip potential of the front axle.

In one embodiment, it is provided that at least some of the following variables, preferably all of the following variables are used to calculate the target grip reserve of the rear axle: driving speed, lateral acceleration, change in lateral acceleration, longitudinal wheel load transfer, brake pressure, accelerator pedal position, sideslip angle, coefficient of friction of the tires and driving program.

In an advantageous further development, it is possible that the roll moment distribution is controlled as a function of the sideslip angle and the driving speed when the sideslip angle threshold is exceeded.

A variable sideslip angle threshold which is set as a function of the driving mode can preferably be used.

### BRIEF DESCRIPTION OF THE DRAWING

Further features and advantages of the present invention will become apparent from the following description of a preferred embodiment example with reference to the accompanying FIGURE.

FIG. 1 shows a schematically highly simplified illustration of a motor vehicle 1 equipped with an active roll support system 4.

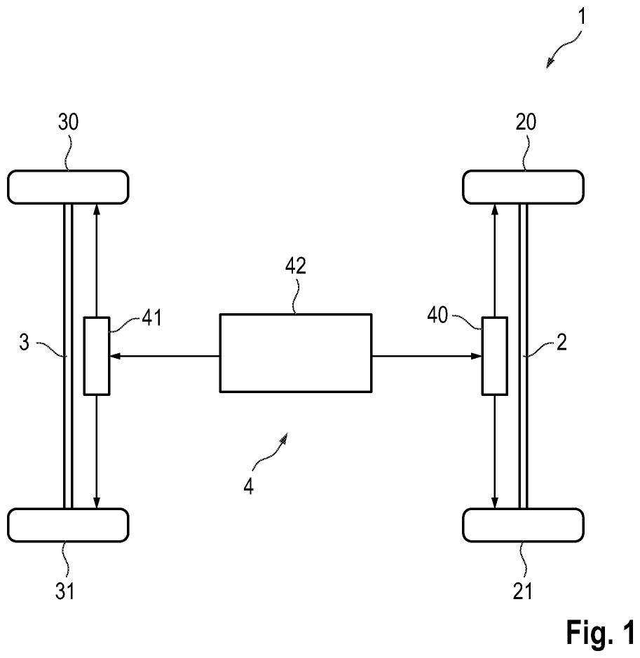

### DETAILED DESCRIPTION OF THE INVENTION

The motor vehicle 1 comprises a front axle 2 with two wheels 20, 21 and a rear axle 3 with two wheels 30, 31 in a per se known manner. The motor vehicle 1 further comprises an active roll support system 4, which is configured to provide roll support for the motor vehicle 1 by means of a roll moment distribution when the motor vehicle 1 is driving. This roll support is intended to minimize or, ideally, completely prevent rolling movements of the motor vehicle 1 when cornering.

The roll support system 4 comprises a first roll stabilizer means 40, which is associated with the front axle 2 of the motor vehicle 1 and acts on the two wheels 20, 21 of the front axle 2, in particular on the wheel suspensions of the two wheels 20, 21 of the front axle 2. The roll support system 4 further comprises a second roll stabilizer means 41, which is associated with the rear axle 3 of the motor vehicle 1 and acts on the two wheels 30, 31 of the rear axle 3, in particular on the wheel suspensions of the two wheels 30, 31 of the rear axle 3. The roll support system 4 also comprises a control device 42 for operating the roll stabilizer means 40, 41 when the motor vehicle 1 is driving.

When carrying out a method for operating the active roll support system 4, the control device 42 is used to calculate the respective grip potential available for longitudinal and lateral forces for each of the wheels 20, 21 of the front axle 2 and for each of the wheels 30, 31 of the rear axle 3 taking into account the following variables, some of which are fixed predetermined variables and some of which are measured values, which are acquired using corresponding sensor means of the motor vehicle 1 that are not explicitly shown here: wheel load, wherein the wheel load forms a feedback path of the actual control variable “roll moment distribution” in the control loop, slip angle, slip, tire temperature, wheel camber, coefficient of friction of the tires.

The current utilization of the grip potential for longitudinal and lateral forces is thus calculated for each of the four corner regions of the motor vehicle 1, i.e., front left, front right, rear left and rear right, taking into account the longitudinal and lateral forces currently acting when the vehicle is driving. This is then used to calculate the currently available grip potential of the rear axle 3 and the currently available grip potential of the front axle 2.

Subsequently, the difference between the two grip potentials, i.e., the difference between the currently available grip potential of the rear axle 3 and the currently available grip potential of the front axle 2, is calculated, which represents the actual grip reserve of the rear axle 3 relative to the front axle 2 and to which the roll moment distribution is regulated. The feedback into the control loop for the roll moment distribution is achieved via the wheel loads, which are included in the calculation of the individual grip potential of all four wheels 20, 21, 30, 31 of the motor vehicle 1.

At least some of the following variables, preferably all of the following variables, are preferably used to determine a target grip reserve of the rear axle 3, from which a control deviation and thus also an adjustment of the roll moment distribution is calculated together with the actual grip reserve of the rear axle 3: driving speed, lateral acceleration, change in lateral acceleration, longitudinal wheel load transfer, brake pressure, accelerator pedal position, sideslip angle, coefficient of friction of the tires and driving program.

When a sideslip angle threshold is exceeded, the control device 42 switches to a sideslip angle- and driving speed-dependent control of the roll moment distribution. If the sideslip angle falls below the threshold again, the grip reserve of the rear axle 3 is once again regulated in the manner described above. Preferably, a variable sideslip angle threshold, which is set as a function of the driving mode of the motor vehicle 1, is used.

What is claimed is:

1. A method for operating an active roll support system of a motor vehicle, in which a roll moment distribution is regulated below a sideslip angle threshold on a basis of an actual grip reserve of a rear axle relative to a front axle of the motor vehicle, said method comprising:
(a) acquiring a wheel load for each wheel of the front axle and for each wheel of the rear axle,
(b) calculating the actual grip reserve of the rear axle using the acquired wheel loads as feedback variables in a control loop for regulating the roll moment distribution,
(c) comparing the actual grip reserve of the rear axle with a target grip reserve of the rear axle, and
(d) determining, based on the comparison at step (c), a control deviation for adapting the roll moment distribution.

2. The method according to claim 1, further comprising calculating a grip potential available for longitudinal and lateral forces for each of the wheels of the front axle and for each of the wheels of the rear axle using at least two of the following variables: wheel load, slip angle, slip, tire temperature, wheel camber and coefficient of friction.

3. The method according to claim 2, further comprising calculating a currently available grip potential of the front axle from the grip potentials of the wheels of the front axle, and calculating a currently available grip potential of the rear axle from the grip potentials of the wheels of the rear axle.

4. The method according to claim 3, further comprising determining the actual grip reserve of the rear axle by calculating a difference between the currently available grip potential of the rear axle and the currently available grip potential of the front axle.

5. The method according to claim 1, further comprising using at least two of the following variables to calculate the target grip reserve of the rear axle: driving speed, lateral acceleration, change in lateral acceleration, longitudinal wheel load transfer, brake pressure, accelerator pedal position, sideslip angle, coefficient of friction of the tires and driving program.

6. The method according to claim 1, further comprising controlling the roll moment distribution as a function of the sideslip angle and a driving speed when the sideslip angle threshold is exceeded.

7. The method according to claim 1, further comprising using a variable sideslip angle threshold which is set as a function of the driving mode.
